(19) United States
(12) Patent Application Publication
(10) Pub. No.: US 2014/0162059 A1
(43) Pub. Date: Jun. 12, 2014

(54) ADHESIVE COMPOSITION, ADHESIVE TAPE AND ADHESION STRUCTURE

(71) Applicants: Hongmei Wan, Shanghai (CN); Chengyi He, Shanghai (CN); Yunhai Deng, Shanghai (CN)

(72) Inventors: Hongmei Wan, Shanghai (CN); Chengyi He, Shanghai (CN); Yunhai Deng, Shanghai (CN)

(73) Assignee: 3M Innovative Properties Company, St. Paul, MN (US)

(21) Appl. No.: 14/128,017

(22) PCT Filed: Jun. 30, 2011
(86) PCT No.: PCT/CN2011/076694

§ 371 Date: Dec. 20, 2013

(51) Int. Cl. C09J 171/08; C09J 7/02; C09J 133/00

(52) U.S. Cl. CPC C09J 171/08; C09J 133/00; C09J 7/0217
USPC 428/355 AC; 524/141

(57) ABSTRACT

A halogen-free pressure-sensitive adhesive composition is provided, based on the total weight of the composition, comprising (A) 15-60 wt % of acrylic-based polymer, (B) 10-50 wt % of thermally conductive filler, and (C) 20-50 wt % of halogen-free flame retardant, based on 100% of the total weight of the composition, wherein the component (C) comprises: sub-component (C1) comprising at least one organophosphorous-based flame retardant; and sub-component (C2) comprising at least one flame retardant selected from the group consisting of nitrogen-containing compound-based flame retardants, graphite material-based flame retardants, melamine cyanurate-based flame retardants, metal hydroxide-based flame retardants, metal oxide-based flame retardants, metal phosphate-based flame retardants other than the organophosphorous-based flame retardants of (C1), and the composition has a P content no less than 4.0 wt %, based on 100 wt % of the total weight of the composition. A halogen-free pressure-sensitive adhesive tape and an adhesion structure are also provided.

### TECHNICAL FIELD

The present invention relates to a halogen-free pressure-sensitive adhesive composition and a halogen-free pressure-sensitive adhesive tape. More specifically, the present invention relates to a halogen-free pressure-sensitive adhesive tape, which can be easily used to bond electric or electronic product without the help of conventional mechanical bolts and can provide an excellent balance of various properties including non-halogen flame retardant property, good bond strength, high thermal conductivity and good dielectric properties, and also relates to a halogen-free pressure-sensitive adhesive composition suitably used for the above-described halogen-free pressure-sensitive adhesive tape. Furthermore, the present invention relates to an adhesion structure equipped with the halogen-free pressure-sensitive adhesive tape of the present invention.

### BACKGROUND OF ART

Hitherto, so-called halogen-free pressure-sensitive adhesive tapes of various types, such as halogen-free pressure-sensitive adhesive film and halogen-free pressure-sensitive adhesive tab, have been proposed and used in practice according to diversified purposes.

KR100774441 (B1) “CONDUCTIVE ADHESIVE TAPE” disclosed an acrylic-based polymer pressure sensitive adhesive tape which is thermally conductive, but the adhesive has no flame retardant property. JP2000281997 (A) “THERMALLY CONDUCTIVE, FLAME-RETARDANT PRESSURE-SENSITIVE ADHESIVE AND HALOGEN-FREE PRESSURE-SENSITIVE ADHESIVE TAPE” disclosed a flame retardant acrylic-based composition. However, the composition was disclosed that has low thermal conductivity. Recently, the electric and electronic product and commodity industry is developing at high speed and needs more and more interface bonding materials to meet various functional requirements. However, the industry still uses conventional mechanical method to bond a thermal interface material to electric and electronic products. Specifically, they need to drill holes in the chips, drill holes in the radiator, buy screw, gasket, screw cap as well as thermal grease, and finally they need to go through a very complicated, high cost and time-consuming approach.

Therefore, a halogen-free pressure-sensitive adhesive tape was innovatively invented and used to bond two components in electric and electronic products, especially in miniaturized electric and electronic products, in a simple, effective and low cost way by its multifunctional properties.

### SUMMARY

The present invention overcomes the above-described shortcomings in prior art technologies.

An objective of at least one embodiment of the present invention is to provides a halogen-free pressure-sensitive adhesive tape which can be easily used to bond the electric and electronic products in a simple, effective and low cost way and needs no mechanical attachment means, and a halogen-free pressure-sensitive adhesive composition useful for the preparation of such a halogen-free pressure-sensitive adhesive tape. At least one embodiment of the present invention also aims to provide a halogen-free pressure-sensitive adhesive tape having excellent balance of the adhesive strength and non-halogen flame retardant property, thermal conductivity and dielectric properties, and a halogen-free pressure-sensitive adhesive composition useful for the preparation of such a halogen-free pressure-sensitive adhesive tape.

In addition, at least one embodiment of the present invention also aims to provide an adhesion structure equipped with the above-described halogen-free pressure-sensitive adhesive tape.

At least one aspect of the present invention provides a halogen-free pressure-sensitive adhesive composition, based on the total weight of the composition, comprising (A) 15˜60 wt % of acrylic-based polymer, (B) 10˜50 wt % of thermally conductive filler, and (C) 20˜50 wt % of halogen-free flame retardant based on the total weight of the composition, wherein the component (C) comprises: sub-component (C1) comprising at least one organophosphorus-based flame retardant; and sub-component (C2) comprising at least one flame retardant selected from the group consisting of hydrous metal compound-based flame retardants, nitrogen-containing compound-based flame retardants, graphite material-based flame retardants, melamine cyanurate-based flame retardants, metal hydroxide-based flame retardants, metal oxide-based flame retardants, metal phosphate-based flame retardants and metal borate-based flame retardants, and organophosphate-based flame retardants other than the organophosphrous-based flame retardants of (C1), and the composition has a P content no less than 4.0 wt % based on the total weight of the composition.

At least one other aspect of the present invention provides a halogen-free pressure-sensitive adhesive tape made of the above composition. According to at least one embodiment of the present invention, the halogen-free pressure-sensitive adhesive tape comprises a carrier and a halogen-free pressure-sensitive adhesive layer provided on at least one surface of the carrier and comprising the above-described halogen-free pressure-sensitive adhesive composition of at least one embodiment of the present invention. The halogen-free pressure-sensitive adhesive tape can be easily used to bond the electric and electronic products in a simple, effective and low cost way and needs no mechanical attachment means, because the invented excellent property balance of the adhesive strength, non-halogen flame retardancy, thermal conductivity and dielectric strength.

At least yet one other aspect of the present invention provides an adhesion structure equipped with the above-described halogen-free pressure-sensitive adhesive tape. The adhesion structure of at least one embodiment of the present invention comprises the halogen-free pressure-sensitive adhesive tape of at least one embodiment of the present invention in combination with an adherend and therefore, this adhesion structure can express the above-described noticeable effects ascribable to use of the halogen-free pressure-sensitive adhesive tape and can be advantageously used in various fields.

These and other aspects of the present invention will be easily understood from the following detailed description.

The halogen-free pressure-sensitive adhesive composition, halogen-free pressure-sensitive adhesive tape and adhesion structure of at least one embodiment of the present invention each is described below in detail.

### DETAILED DESCRIPTION

The present invention comprises the following aspects:

1. At least one embodiment of the present invention relates to a halogen-free pressure-sensitive adhesive composition, based on the total weight of the composition, comprising (A) 15˜60 wt % of acrylic-based polymer, (B) 10˜50 wt % of thermally conductive filler, and (C) 20˜50 wt % of halogen-free flame retardant, based on 100 wt % of the total weight of the composition, wherein the component (C) comprises: sub-component (C1) comprising at least one organophosphorus-based flame retardant; and sub-component (C2) comprising at least one flame retardant selected from the group consisting of nitrogen-containing compound-based flame retardants, graphite material-based flame retardants, melamine cyanurate-based flame retardants, metal hydroxide-based flame retardants, metal oxide-based flame retardants, metal phosphate-based flame retardants and metal borate-based flame retardants, and organophosphate-based flame retardants other than the organophosphrous-based flame retardants of (C1), and the composition has a P content no less than 4.0 wt %, based on 100 wt % of the total weight of the composition. According to some preferred embodiments, said sub-component (C2) comprises at least one flame retardant selected from the group consisting of metal hydroxide-based flame retardants, metal oxide-based flame retardants, metal phosphate-based flame retardants, metal borate-based flame retardants and organophosphate-based flame retardants other than the organophosphrous-based flame retardants of (C1).
2. According to some embodiments of the present invention of aspect 1, said component (C) has a total phosphorus (P) content of no less than 4.5 wt %, based on 100 wt % of the total weight of the composition.
3. According to some embodiments of the present invention of aspect 1, said sub-component (C1) has a P content no less than 5.0 wt %, based on 100 wt % of the total weight of the composition.
4. According to some embodiments of the present invention of any one of foregoing aspects, wherein the amount of said sub-component (C1) is 10-35 wt %, based on 100 wt % of the total weight of the composition.
5. According to some embodiments of the present invention of any one of foregoing aspects, the amount of sub-component (C2) is from 5% to 40%, based on 100 wt % of the total weight of the composition.
6. According to some embodiments of the present invention of any one of foregoing aspects, said sub-component (C2) comprises at least one phosphate-based flame retardant other than the organophosphorus-based flame retardant of (C1). Among them, the amount of said sub-component (C1) is 12-35 wt %, preferably 18-35 wt %, based on 100 wt % of the total weight of the composition, and the amount of said sub-component (C2) is f 5-19 wt %, based on 100 wt % of the total weight of the composition.
7. According to some embodiments of the present invention of any one of foregoing aspects, said sub-component (C2) comprises at least one metal hydroxide-based flame retardant.
8. According to some embodiments of the present invention of any one of foregoing aspects, said sub-component (C2) comprises at least one metal borate-based flame retardant and/or at least one metal phosphate-based flame retardant.
9. According to some preferred embodiments of the present invention of any one of foregoing aspects, said metal borate is zinc borate.
10. According to some preferred embodiments of the present invention of any one of foregoing aspects, said metal phosphate is zinc phosphate.
11. According to some embodiments of the present invention of any one of aspects 7-10, the amount of said sub-component (C1) is 10-26 wt %, based on 100 wt % of the total weight of the composition, said (C1) comprising at least one metal hydroxide-based flame retardant in an amount of 8-24 wt %, based on 100 wt % of the total weight of the composition, and at least one metal borate-based flame retardant or metal phosphate-based flame retardant in an amount of 1-10 wt %, based on 100 wt % of said at least one metal hydroxide-based flame retardant.
12. According to some embodiments of the present invention of any one of aspects 7-10, the amount of said sub-component (C1) is 10-24 wt % based on 100 wt % of the total weight of the composition, said (C1) comprising at least one metal hydroxide-based flame retardant in an amount of 10-21 wt %, based on 100 wt % of the total weight of the composition, and comprising at least one metal borate-based flame retardant or metal phosphate-based flame retardant in an amount of 1-10 wt %, based on 100 wt % of said at least one metal hydroxide-based flame retardant.
13. According to some embodiments of the present invention of any one of aspects 7-10, the total amount of said component (B) and the sub-component (C2) is no less than 30 wt %, based on based on 100 wt % of the total weight of the composition.
14. According to some embodiments of the present invention of any one of aspects 7-13, said sub-component (C2) further comprises at least one phosphate-based flame retardant other than the organophosphorus-based flame retardant of (C1).
15. According to some embodiments of the present invention of aspect 12, the amount of said sub-component (C1) is 12-26 wt %, based on 100 wt % of the total weight of the composition, said (C1) comprising at least one metal hydroxide-based flame retardant in an amount of 8-24 wt %, based on 100 wt % of the total weight of the composition at least one metal borate-based flame retardant or metal phosphate-based flame retardant in an amount of 1-10 wt %, based on 100 wt % of said at least one metal hydroxide-based flame retardant, and at least one phosphate-based flame retardant in an amount of 0.001-19 wt %, based on 100 wt % of the total weight of the composition.
16. According to some embodiments of the present invention of aspect 12, the amount of said sub-component (C1) is 15-31 wt %, based on 100 wt % of the total weight of the composition, said (C1) comprising at least one metal hydroxide-based flame retardant in an amount of 5-31 wt %, based on 100 wt % of the total weight of the composition, at least one metal borate-based flame retardant or metal phosphate-based flame retardant in an amount of 1-10 wt %, based on 100 wt % of said at least one metal hydroxide-based flame retardant, and at least one phosphate-based flame retardant in an amount of 0.001-14 wt %, based on 100 wt % of the total weight of the composition.
17. According to some embodiments of the present invention of any one of foregoing aspects, said organophosphorus-based flame retardant is an organophosphorus salt.
18. According to some embodiments of the present invention of any one of foregoing aspects, said organophosphate-based flame retardant is a triphenyl phosphate.
19. According to some embodiments of the present invention of any one of foregoing aspects, said metal hydroxide-based flame retardant is aluminum hydroxide.
20. According to some embodiments of the present invention of any one of foregoing aspects, said acrylic-based polymer is at least one polymer of one or more monomer selected from the group consisting of acrylic acid, methyl acrylate, and acrylate monomers.
21. According to some embodiments of the present invention of any one of foregoing aspects, said acrylic-based polymer has an intrinsic viscosity (IV) of at least 0.8, preferably 1.0, and a solid content of at least 30 wt %.
21. According to some embodiments of the present invention of any one of foregoing aspects, said acrylic-based polymer is at least one polymer of one or more monomer selected from the group consisting of butyl (meth)acrylate, hexyl(meth)acrylate, and 2-ethylhexyl(meth)acrylate.
22. According to some embodiments of the present invention of any one of foregoing aspects, said thermally conductive filler is selected from the group consisting of ceramic, metal oxides, hydrated metal compounds, metal nitrides, and hydrous metal compounds.
23. According to some embodiments of the present invention of any one of foregoing aspects, said thermally conductive filler is selected from the group consisting of Al(OH)₃, BN, SiC, AlN, Al₂O₃, and Si₃N₄.
24. According to some embodiments of the present invention of any one of foregoing aspects, the composition further comprises a tackifier.
25. According to some embodiments of the present invention of any one of foregoing aspects, said composition has a V1 non-halogen flame retardant rating under UL94, a bond strength higher than 0.28 MPa in terms of cleavage adhesion force, a thermal conductivity higher than 0.60 W/m·k and a dielectric property higher than 0.30 kv/mil.
26. According to some embodiments according to the present invention of any one of foregoing aspects, wherein said composition has a V0 non-halogen flame retardant rating under UL94, a bond strength higher than 0.40 MPa in terms of cleavage adhesion force, a thermal conductivity higher than 0.65 W/m·k and a dielectric property higher than 0.40 kv/mil.
27. At least one embodiment of the present invention also relates to a halogen-free pressure-sensitive adhesive tape comprising a carrier and a halogen-free pressure-sensitive adhesive layer provided on at least one surface of said carrier, said halogen-free pressure-sensitive adhesive layer comprising the halogen-free pressure-sensitive adhesive composition described in any one of the above aspects 1-26.
28. According to some embodiments of the present invention of aspect 27, said carrier is a plastic film or an insulating woven, nonwoven material.
29. According to some embodiments of the present invention of aspect 27 or 28, said halogen-free pressure-sensitive adhesive layer has a thickness of 10-10000 μm.
30. At least one embodiment of the present invention yet further relates to an adhesion structure comprising a halogen-free pressure-sensitive adhesive tape described in any one of preceding aspects 27-29 and an adherend having attached thereto said halogen-free pressure-sensitive adhesive tape through said halogen-free pressure-sensitive adhesive layer.
31. According to some embodiments of the present invention of aspect 30, said adherend is an electric or electronic product.
32. According to some embodiments of the present invention of aspect 30 or 31, said adherend is a miniaturized electric or electronic part.

The halogen-free pressure-sensitive adhesive tapes according to at least some embodiments of the present invention have an excellent balance of the adhesive strength, non-halogen flame retardant property, thermal conductivity and dielectric properties and thus can be advantageously applied to various adherends, for example electric and electronic products. In one aspect thereof, the halogen-free pressure-sensitive adhesive tape of the present invention, when it is applied to an electric and electronic product, can be sufficiently bonded without the help of mechanical attachment means. Further, in another aspect thereof, the halogen-free pressure-sensitive adhesive tape of at least some embodiments of the present invention, when applied to a miniaturized electronic product, can be strongly adhered to such adherends, and can simultaneously provide a non-halogen flame retardant property (UL94-V0 rating), a high thermal conductivity (0.65 W/m·k or more), good dielectric properties (higher than 0.40 kv/mil) and a good bond strength in terms of cleavage adhesion force (0.40 MPa or more).

According to some embodiments of the present invention, the above-described aspects can be attained by a halogen-free pressure-sensitive adhesive composition which comprises, based on the total weight of the composition, (A) 15˜60 wt % of acrylic-based polymer, (B) 10˜50 wt % of thermally conductive filler, and (C) 20˜50 wt % of halogen-free flame retardant, based on 100 wt % of the total weight of the composition, wherein the component (C) comprises: sub-component (C1) comprising at least one organophosphorus-based flame retardant; and sub-component (C2) comprising at least one flame retardant selected from the group consisting of nitrogen-containing compound-based flame retardants, graphite material-based flame retardants, melamine cyanurate-based flame retardants, metal hydroxide-based flame retardants, metal oxide-based flame retardants, metal phosphate-based flame retardants and metal borate-based flame retardants, and organophosphate-based flame retardants other than the organophosphrous-based flame retardants of (C1), and the composition has a P content no less than 4.0 wt %, based on 100 wt % of the total weight of the composition. Also, according to at least some embodiments of the present invention, a halogen-free pressure-sensitive adhesive tape comprising a carrier and a halogen-free pressure-sensitive adhesive layer provided on at least one surface of the carrier, the halogen-free pressure-sensitive adhesive layer comprising the above-described halogen-free pressure-sensitive adhesive composition, is provided.

Furthermore, according to at least some embodiments of the present invention, an adhesion structure comprising a halogen-free pressure-sensitive adhesive tape of an embodiment of the present invention and an adherend having attached thereto the halogen-free pressure-sensitive adhesive tape by the halogen-free pressure-sensitive adhesive layer, wherein the halogen-free pressure-sensitive adhesive tape can be easily and sufficiently bonded to an electric and electronic product, is provided.

As can be well understood from the following detailed description, when the pressure-sensitive adhesive composition of embodiments of the present invention is used, a pressure-sensitive adhesive tape capable of so-called “one-stop and easy solution”, which can be easily attached to an adherend with sufficient bond strength and balanced multifunctional properties, can be provided. The halogen-free pressure-sensitive adhesive tape of embodiments of the present invention not only requires no mechanical attachment means, for example, screws or bolts, but also meets many the requirements in wide applications such as, for example, power supplies, light emitting diode (LED), automotives, electronics, motors, telecom, semiconductors, hand held machines (HHM) products, etc.

The adhesion structure of embodiments of the present invention comprises the halogen-free pressure-sensitive adhesive tape of embodiments of the present invention in combination with an adherend and therefore, this adhesion structure can express the above-described noticeable effects ascribable to use of the halogen-free pressure-sensitive adhesive tape and can be advantageously used in various fields.

Acrylic-Based Polymer

Acrylic polymers suitable for use in the present invention are not specifically limited, and any acrylic polymer resin used as an adhesive in the conventional art may be used without limitations. The base polymer used in the adhesive composition can be obtained either by aforehand polymerization before being used in the present invention, or by the UV polymerization process during the process of mixing with other materials.

Preferred examples of the acrylic polymer resin include polymers formed by copolymerization of a (meth)acrylic ester monomer having an alkyl group of 1˜12 carbon atoms with a polar monomer suitable for copolymerization with the (meth)acrylic ester monomer.

Examples of the (meth)acrylic ester monomer having an alkyl group of 1˜12 carbon atoms include, but are not limited to, butyl (meth)acrylate, hexyl(meth)acrylate, n-octyl(meth)acrylate, isooctyl(meth)acrylate, 2-ethylhexyl(meth)acrylate or isononyl(meth)acrylate.

Examples of the polar monomer copolymerizable with the (meth)acrylic ester monomer include, but are not limited to, carboxyl group-containing monomers, such as (meth)acylate acid, maleic acid and fumaric acid, or nitrogen-containing monomers, such as N-vinyl pyrrolidone and acrylamide, etc. These polar monomers can act to provide cohesion property to the adhesive and to improve adhesion strength.

The content of the polar monomer to the (meth)acrylic ester monomer is not specifically limited and the amount of the polar monomer is preferably 1˜20 wt % based on the total weight of all monomers.

The molecular weight of the acrylic polymer is also not specifically limited. Acrylic polymer with IV >0.8 and preferably >1.0 and with glass transition temperature of −30° C. or lower is preferably used in the present invention.

Specific examples of acrylic polymer suitable for use in the present invention are those available from 3M China under the trade designations CSA3060, CSA3075 and CSA3100. The content of the acrylic base polymer in total composition is 15 to 60 weight %, more preferably 20˜50 weight %, based on 100 wt % of the total weight of the composition

Flame Retardant

Organophosphorus-based flame retardant is used as a subcomponent (C1) of component (C). Examples of organophosphorus-based flame retardants include but not limited to organophosphates and organophosphorus salts. For example, an organophosphorus salt, OP935 commercially available from Clariant Chemicals Company, with high phosphor content, 23˜24 wt %, in solid filler type, was preferably used as the subcomponent (C1) in this invention.

The non-halogen flame retardant used as the subcomponent (C2) may be selected from the group consisting of nitrogen-containing compound-based flame retardants, graphite material-based flame retardants, melamine cyanurate-based flame retardants, metal hydroxide-based flame retardants, metal oxide-based flame retardants, metal phosphate-based flame retardants and metal borate-based flame retardants, and organophosphate-based flame retardants other than the organophosphrous-based flame retardants of (C1). Suitable examples include but not limited to MPP (melamine poly phosphate), Mg(OH)2, Al(OH)3, Zinc borate, APP (ammonium polyphosphate), DMMP (Dimethyl methylphosphonate), TPP(Triphenyl phosphate), zinc phosphate, MCA (melamine cyanurate), MP (Melamine phosphate), DOPO (9,10-Dihydro-9-oxa-10-phosphaphenanthrene 10-oxide), etc.

In order to avoid a decrease in the adhesive's bond strength that can be caused by filler type flame retardants, the present inventors found that several different types of FR agents were preferably added together. The great synergy between different type flame retardants was unexpectedly achieved and fully utilized to decrease the usage volume and get high bond strength.

For sub-component (C2), in some embodiments, Metal hydroxide flame retardant material was preferably selected to use with phosphorus salt of (C1) because it provided good synergy effects with phosphorus compounds and further provided good thermal conductivity. Mg(OH)₂, Al(OH)₃ could be used, preferably Al(OH)₃, for example, ATH commercially available from Xusen Company.

Also for sub-component (C2), in some embodiments, metal borate and/or metal phosphate flame retardant material, such as Zinc borate or Zinc phosphate was added because it provided good synergy with OP935 and ATH. Zinc borate was preferably used. Zinc borate is available from, for example, Xusen Company.

Also for sub-component (C2), in some embodiments, organophosphate flame retardant material, such as P30 available from Chengzaicheng company (a liquid flame retardant polymer), was added to t help increase the tackiness property of the adhesive composition without causing a loss of flame retardance.

Total flame retardants are added in an amount in the range of 20˜50 wt %, based on 100 wt % of the total weight of the composition. According to some embodiments of the present invention, said component (C) has a total phosphorus (P) content of no less than 4.0 wt %, preferably 4.5 wt %, and most preferably 5.0 wt %, based on 100 wt % of the total weight of the composition. According to some other embodiments of the present invention, said sub-component (C1) has a phosphorus (P) content of no less than 5.0 wt %, based on 100 wt % of the total weight of the composition. According to some embodiments of the present invention, said component (C) has a total phosphorus (P) content of no higher than 10 wt %, preferably 9 wt %, and more preferably 8.5 wt %, based on 100 wt % of the total weight of the composition.

Thermally Conductive Filler

The composition of the present invention contains thermally conductive fillers. Electrically insulating, thermally conductive filler was preferably used to get high electrically insulating properties in addition to the thermally conductive properties. Suitable materials include, but not limited to, ceramic, metal oxides, metal nitride, metal hydroxide compounds (for example, Al(OH)₃), BN, SiC, AlN, Al₂O₃, Si₃N₄, and the like. The thermally conductive filler preferably has a thermal conductivity of 100 W/m·k or more. These fillers may be used alone, or two or more kinds of them may be used in combination. The amount of the thermally conductive filler is in the range of 10˜50 wt %, based on 100 wt % of the total weight of the composition. If the amount of filler is less than 20 wt %, the heat conductivity may be reduced, while if it is higher than 50 wt %, the cohesion of the sheet may be weakened. Fillers with different particle sizes may be used simultaneously in combination. The preferred mean particle size is in the range of 1˜50 μm depending on the thickness of sheet. For improved cohesion of sheet, a filler which has been surface-treated with silane, titanate or the like may be used. BN fillers with different particle sizes are preferably used. Examples of suitable thermally conductive fillers include, but not limited to, PT120 and CF100, commercially available from Momentive company.

Optional Components

The compositions and tapes of embodiments of the present invention may also contain additives such as tackifiers, antioxidants, cross-linkers, thickeners, auxiliary flame retardants, antifoaming agents, pigment, surfactant, surface-modifiers and the like to provide the flame retardant insulating tapes of embodiments of the present invention with preferable physical properties depending on their use.

In order to obtain high bond strength, a tackifier resin was preferably used in some embodiments of the adhesive composition of the present invention. Preferred tackifiers include one or more types selected from the group consisting of Terpene Phenol Resin, Rosin ester resin and the like. Preferred tackifiers are those having different softening points, which can provide the adhesive composition with good tackiness and adhesiveness. Examples of suitable tackifiers include, but not limited to, TP2040, GAAT, GA90A, which are available from Arizona Chemical, Arizona Chemical and Wu Zhou Sun Shine Company, respectively.

Carrier

There is no limitation to the tape carrier suitable for the present invention. Any conventional carrier material used in the present field may be used in the present invention. For example, the carrier may be super thin plastic film (for example, a film with a thickness less than 50 μm, preferably less than 30 μm) such as polyimide (PI) film and thermal conductive polyethylene terephthalate (PET) film, or insulating woven or nonwoven material, such as glass fibre cloth. A cloth preferred for some embodiments of the present invention is glass cloth, such as that is commercially available from Shanghai Boshe Industry Company.

Production Process of adhesive tape may be described as follows.

The halogen-free pressure-sensitive adhesive tape of embodiments of the present invention can be produced according to an arbitrary method conventionally employed for the production of a pressure-sensitive adhesive tape or the like. For example, the halogen-free pressure-sensitive adhesive composition may be coated directly on one surface or both surfaces of the carrier. Alternatively, a halogen-free pressure-sensitive adhesive layer may be separately formed as an independent layer and then this halogen-free pressure-sensitive adhesive layer may be laminated on the carrier. For the coating, a commonly employed method such as solvent-based coating and solvent-less coating may be used. The surface of the carrier is preferably subjected to a primer treatment in advance of the coating or laminating step to improve the adhesion of halogen-free pressure-sensitive adhesive layer to the carrier. In place of or in addition to the primer treatment, other pretreatments may be applied. Such a pretreatment can be performed with or without a reactive chemical adhesion promoter such as hydroxyethyl acrylate or hydroxyethyl methacrylate, or other reactive species of low molecular weight. The carrier is composed of a polymer film and therefore, corona discharge treatment is generally preferred. The halogen-free pressure-sensitive adhesive tape of embodiments of the present invention is expected to have the above-described excellent balance of various properties and therefore, can be advantageously applied to various adherends including from soft to hard articles. Furthermore, an adhesive structure having excellent properties and the like can be provided. For example, the halogen-free pressure-sensitive adhesive tape of embodiments of the present invention can be advantageously used in many technical fields.

The adhesive tape can be obtained by any method used in the present field. For example, it can be obtained by a solvent-based mixing and coating process or a solvent-less compounding and coating process such as UV or E-beam polymerization process.

Solvent-Based Process:

According to one specific embodiment of the present invention, the adhesive tapes made of the adhesive composition are prepared as follows: Tackifier resin TP2040 and thermally conductive filler BN were added in the solvent that generally used in acrylic adhesive system, such as ethyl acetate or the like. The mixture was sufficiently stirred until the fillers were dispersed uniformly. To the obtained slurry, flame retardant was added in batches sequentially, and then stirred another for a while until the fillers were dispersed uniformly. The slurry was added in batches into the acrylic base polymer CSA3075 under high speed stirring. The optional agent such as surfactant or coupling agent was added sequentially with filler. To the resulting slurry, the crosslinker was added and stirred for a while till much homogeneous adhesive mixture was obtained. The mixture was degassed by a vacuum pump under reduced pressure, and then was coated on a release liner to form the adhesive tape product. More than one adhesive layer may be coated. For example, a layer of carrier material and a second adhesive layer can be successively coated on the adhesive tape product as above to form an adhesive tape with two adhesive layers.

Process by Solvent-Less Method (for Example, UV Polymerization):

For example, one specific embodiment may be as follows: all acrylic monomers were partially polymerized by heating (70° C.) in the reactor to obtain a polymer syrup with a viscosity of 2500˜4500 cps. Then the other parts material including thermal conductive filler, flame retardant materials, additive, photoinitiator and crosslinker were added into above syrup or directly mixing with all monomers, then sufficiently stirred until the fillers were dispersed uniformly. The mixture was degassed by a vacuum pump under reduced pressure and then coated on a polyester release film. Another polyester film was covered on the coating layer. Thereafter the coating layer was irradiated with UV light for 5˜40 minutes, and thereby a thermally conductive flame retardant adhesive tape was obtained.

The following examples and comparative examples were offered to aid in the understanding of the present invention and are not to be construed as limiting the scope thereof. Unless otherwise indicated, all parts and percentages are by weight. The following test methods and protocols were employed in the evaluation of the illustrative and comparative examples that follow:

The compositions of Comparative Examples 1-5 and Examples 1˜9 were prepared according to the following process:

### Example 1

Firstly, the tackifier A (3.9 phr) was dissolved in 250 phr ethyl acetate to form a tackifier solution, Then the thermally conductive fillers A, 40 phr, were added to the tackifier solution in small batches under stirring. Coupling agents, A171 1.0 phr, was added in and the mixture was stirred for about 30 min. Flame retardant filler B 17.0 phr and D 7.7 phr were then added in batches, and the mixture was further stirred for about 30 min until this precursor mixture solution became a homogeneous shiny. The slurry was added in the acrylic-based polymer B, 39.1 phr, by batches under stirring to form the adhesive mixture with a solid content of about 40%. Then the crosslinker RD 1054 1.5 phr was added into the semi-mixed adhesive and stirred for about 30 min until a substantially homogeneous adhesive mixture was obtained. The final adhesive mixture had a solid content of 40%. Then the mixed adhesive composition was coated on release liners and then passed through ovens to dry and produce an ATT (Adhesive Transfer Tape) product. The above adhesive composition was double coated on a glass cloth to form a tape product. The oven equipped on coating line had 4 heating zones with temperatures set at 40° C., 80° C., 110° C., 120° C., respectively. An ATT sample with 70 um thickness was used to test thermal conductivity. Tape sample containing cloth carrier was used to test flame retardant, dielectric and the cleavage property.

### Examples 2˜9

The composition preparation and sample preparation of Examples 2˜9 were the same as that in Example 1, except that the components and ratios were different from those in Example 1. All ratios and compositions were shown in Table 1(1).

### Comparative Example 1

Firstly, the tackifier A (3.9 phr) was dissolved in 250 phr ethyl acetate to form a tackifier solution. Then the thermally conductive filler B (38 phr) was added to the tackifier solution in small batches under stirring. Coupling agents (A171, 1.4 phr) was added and the mixture was stirred for about 30 min. Flame retardant filler B (29.0 phr) was then added in batches, and then the mixture was further stirred for another 30 min until this precursor mixture solution became a homogeneous slurry. The slurry was added Into the acrylic-based polymer B (29.1 phr) in batches under stirring to form the adhesive mixture with a solid content of about 40%. Then the crosslinker RD1054 (1.5 phr) was added into, the semi-mixed adhesive and stirred for about 30 min until a substantially homogeneous adhesive mixture was obtained. The final adhesive mixture had a solid content of 40%. Then the mixed adhesive composition was coated on release liners and then passed through ovens to dry and produced an ATT product (Adhesive Transfer Tape). The above adhesive composition was double coated on a glass cloth to form a tape product. The oven equipped on coating line had 4 heating zones with temperatures set at 40° C., 80° C., 110° C., 120° C. respectively. An ATT sample with 70 μm thickness was used to test thermal conductivity. Tape sample containing cloth carrier was used to test flame retardant, dielectric and the cleavage property.

### Comparative Examples 2˜5

The composition preparation and sample preparation of Comparative Examples 2˜5 were the same as that in Comparative Example 1, except that the components and the ratios were different from those in Comparative Example 1. All components and ratios were shown in Table 1(2).

The formulations of Examples 1˜9 and Comparative Examples 1˜5 were summarized in Table 1(1) and 1(2), respectively.

TABLE 1(1)
Composition of Examples 1-9 (E1-E9)

| Ingredients, parts | E1 | E2 | E3 | E4 | E5 | E6 | E7 | E8 | E9 |
|---|---|---|---|---|---|---|---|---|---|
| Binder component in composition* | 43.0 | 46.3 | 48.3 | 48.7 | 45.8 | 42.3 | 46.5 | 48.0 | 44.4 |
| Acrylic polymer A | 0.0 | 39.2 | 0.0 | 0.0 | 0.0 | 37.1 | 0.0 | 41.7 | 0.0 |
| Acrylic polymer B | 39.1 | 0.0 | 43.9 | 43.0 | 0.0 | 0.0 | 38.7 | 0.0 | 39.4 |
| Acrylic polymer C | 0.0 | 0.0 | 0.0 | 0.0 | 35.7 | 0.0 | 0.0 | 0.0 | 0.0 |
| Tackifier A | 3.9 | 3.9 | 4.4 | 5.7 | 3.9 | 2.8 | 7.8 | 0.0 | 2.4 |
| Tackifier B | 0.0 | 0.0 | 0.0 | 0.0 | 6.2 | 0.0 | 0.0 | 3.1 | 2.6 |
| Tackifier C | 0.0 | 3.3 | 0.0 | 0.0 | 0.0 | 2.4 | 0.0 | 3.2 | 0.0 |
| Cross linker | 1.5 | 1.5 | 1.5 | 1.5 | 1.5 | 1.5 | 1.5 | 1.5 | 1.5 |
| Thermally conductive material A | 40.0 | 0.0 | 15.9 | 0.0 | 13.0 | 22.8 | 0.0 | 0.0 | 32.2 |
| Thermally conductive material B | 0.0 | 40.0 | 0.0 | 8.0 | 10.0 | 0.0 | 12.8 | 14.5 | 0.0 |
| flame retardant A | 0.0 | 0.0 | 14.3 | 23.0 | 11.2 | 12.0 | 26.5 | 6.5 | 0.0 |
| flame retardant B | 17.0 | 13.0 | 19.9 | 19.2 | 18.4 | 23.0 | 12.8 | 30.7 | 22.5 |
| flame retardant C | 0.0 | 0.0 | 1.6 | 1.1 | 1.0 | 0.5 | 1.4 | 0.3 | 0.0 |
| flame retardant D | 7.7 | 14.4 | 0.0 | 9.6 | 9.2 | 6.5 | 8.0 | 6.8 | 6.4 |
| Coupling agent | 1.0 | 1.0 | 1.0 | 1.0 | 1.0 | 1.2 | 1.2 | 1.3 | 1.1 |
| Phosphorus percent, % | 6.70 | 5.73 | 5.38 | 5.15 | 5.85 | 6.87 | 4.80 | 8.20 | 7.73 |

TABLE 1(2)
Composition of Comparative Examples 1-9 (C1-C5)

| Ingredients, parts | C1 | C2 | C3 | C4 | C5 |
|---|---|---|---|---|---|
| Binder component in composition* | 33.0 | 35.0 | 46.6 | 48.6 | 35.9 |
| Acrylic polymer A | 0.0 | 0.0 | 39.4 | 0.0 | 31.5 |
| Acrylic polymer B | 29.1 | 0.0 | 0.0 | 42.9 | 0.0 |
| Acrylic polymer C | 0.0 | 31.8 | 0.0 | 0.0 | 0.0 |
| Tackifier A | 3.9 | 3.2 | 3.9 | 5.7 | 2.4 |
| Tackifier B | 0.0 | 0.0 | 0.0 | 0.0 | 2.1 |
| Tackifier C | 0.0 | 0.0 | 3.3 | 0.0 | 0.0 |
| Cross linker | 1.5 | 1.5 | 1.5 | 1.5 | 1.5 |
| Thermally conductive material A | 0.0 | 42.0 | 0.0 | 0.0 | 0.0 |
| Thermally conductive material B | 38.0 | 0.0 | 31.2 | 0.0 | 0.0 |
| flame retardant A | 0.0 | 0.0 | 0.0 | 51.5 | 60.6 |
| flame retardant B | 29.0 | 23.0 | 21.5 | 0.0 | 0.0 |
| flame retardant C | 0.0 | 0.0 | 0.0 | 0.0 | 3.2 |
| flame retardant D | 0.0 | 0.0 | 0.0 | 0.0 | 0.0 |
| Coupling agent | 1.4 | 1.3 | 1.0 | 0.9 | 1.0 |
| Phosphorus percet, % | 10.29 | 8.70 | 7.01 | 0.00 | 0.00 |

*In the table 1(1) and table 1(2), the binder component means the acrylic polymer(s) plus the tackifier(s).
Note: wherein, except the amount of flame retardant C was based on 100 wt % of the weight of the flame retardant A, all the amounts of the ingredients were based on 100 wt % of the weight of the adhesive compositions.

### Abbreviation of Ingredients in the Table 1(1) and 1(2).

Acrylic polymer A: acrylic polymer CSA3060, IV≧0.8, solid 40%, available in 3M China.
Acrylic polymer B: acrylic polymer CSA3075, IV≧1.0, solid 30%, available in 3M China.
Acrylic polymer C: acrylic polymer CSA3100, IV≧1.2, solid 30%, available in 3M China.
Tackifier A: Alpha-Pinene Phenol Resin, TP2040, soft point: 115˜125° C., Arizona Chemical product.
Tackifier B: liquid type of Rosin ester, GAAT, soft point<40° C., available in Wu zhou Sun shine company.
Tackifier C: Rosin ester, GA90A, soft point: 85˜95° C., available in Wu zhou Sun shine company.
Cross-linker: Aromatic bisamide compound. 3M product, RD-1054 was used with type of 5% xylene solution.
Thermally conductive material A: BN powder, PT120, mean particle size 12˜13 um; Crystal Size, >10 μm; Surface Area, 2 m²/g, Tap Density, 0.55 g/cc, D10/D90: 5/25 um, Momentive product.
Thermally conductive material B: BN powder, CF200 mean particle size 8˜15 um; Surface Area, 3˜5 m²/g, Tap Density, 0.35 g/cc, <25% 4.45 um, <50% 7.3 um, <75% 10.5 um, <90% 13.4 um, Yingkou Pengda chemical material company.
Flame retardant A: metal hydrate, ATH, mean particle size 5˜10 um; D10/D90: 1/15 um, preferable material used in invention is Aluminum hydrate, Suzhou Ruifeng Material company product.
Flame retardant B: powder material of organophosphorus salt, OP935, Phosphorus content, 23˜24% wt, particle size, D95<10 um, Phosphorus content, 23.3˜24% wt, Density 1.2 g/cm3, decomposition temperature>300 C, Pei Xing Trading Company.
Flame retardant C: Zinc borate compound, ZB, mean particle size: 1˜2 um, Suzhou Ruifeng Material Company product.
Flame retardant D: liquid type flame retardant, P30, mixture of Triphenyl phosphate (CAS: 115-86-6) with aromatic phosphate ester, Phosphorus content, 8˜9% wt, Chengzaicheng Company.
Coupling agent: silane coupling agent and organic titanate coupling agent, A171 is applicable in the invention, Dow Corning product.

Test Method and Data

Flame Retardancy Test:

According to the UL-94 (Standards established by U.S. Underwriters' Laboratories Inc.) vertical burning test, a flame was placed under the sample for 10 seconds and then removed, and the time taken for the sample to stop burning was measured. After the sample stopped burning, the flame was placed again under the sample for a further 10 seconds and then removed, and the time taken for the sample to stop burning was measured. A pair of 5 samples was evaluated (the burning time was measured a total of 10 times). The maximum burning time of 10 burning times, the total of 10 burning times, and whether or not there are drips during burning were evaluated. The rating for flame retardancy classification is given below. The other details are according to the UL-94 standards.

V-0: Maximum burning time, 10 seconds or less; total burning time, 50 seconds or less; no drips.
V-1: Maximum burning time, 30 seconds or less; total burning time, 250 seconds or less; no drips.
V-2: Maximum burning time, 30 seconds or less; total burning time, 250 seconds or less; drips permitted.
Burning: The above conditions not satisfied.

Sample making: each of the prepared composition adhesive was coated on a liner to form an adhesive film, and then the adhesive film was laminated to make the test specimen with thickness 1.0 mm, width 12.5 mm, length 127 mm. Test data were shown in Table 2(1) and 2(2).

Thermal Conductivity:

Each of the prepared composition adhesive films was cut into a wafer with diameter 30 mm, and thermal conductivity of the samples was measured with the thermal conductivity meter DRL-II (Xiangtan Yiqiyibiao Company, China) based on the test standard GB 5598-85. Test data were shown in Table 2(1) and 2(2).

Bond Strength Test (Cleavage Adhesion Test):

Tensile test equipment (Instron 5565), Aluminum test block holders and test jigs (the tool used to pull and cleave the Aluminum blocks) were used in this test. Aluminum test blocks was customized to have a test surface with 1 in*1 in area.

Each of the prepared adhesive composition was coated on a liner to form adhesive film/sheet with 0.15 mm thickness, and then cut into 1″ [25.4 mm]×1″ [25.4 mm] size. One side of the prepared adhesive film was attached to the test surface of Al holder, then removed liner on other side of tape, laminated it to another Aluminum block test surface. Pressed the holder with Instron with a pressure 2000N+/−100N, pressing time maintain 20 s. The samples dwell at room temperature for 1 hours. Assembly jigs to the block holders, clamp two end of block and pull/cleave the two holders by Instron at speed of 50.8 mm/min, and the maximum force during the cleavage process were recorded. Test data were shown in Table 2(1) and 2(2).

Dielectric Strength:

Dielectric strength test was performed to each composition adhesive film samples with 0.18 mm thickness according to the standard ASTM 1000-D149. Test data were shown in Table 2(1) and Table 2(2).

TABLE 2(1)
Test data of Examples 1-9 (E1-E9)

| Test Data | E1 | E2 | E3 | E4 | E5 | E6 | E7 | E8 | E9 |
|---|---|---|---|---|---|---|---|---|---|
| Flame retardancy | V1 | V1 | V1 | V0 | V0 | V0 | V0 | V0 | V0 |
| (UL94) | | | | | | | | | |
| Thermally conductivity | 1.33 | 1.31 | 0.81 | 0.71 | 1.10 | 0.93 | 1.43 | 0.70 | 1.21 |
| (W/mk) | | | | | | | | | |
| Dielectrical strength | 0.42 | 0.45 | 0.42 | 0.54 | 0.51 | 0.46 | 0.42 | 0.61 | 0.45 |
| (Kv/mil) | | | | | | | | | |
| Cleavage adhesion | 0.346 | 0.307 | 0.660 | 0.553 | 0.501 | 0.600 | 0.518 | 0.710 | 0.654 |
| (MPa) | | | | | | | | | |

TABLE 2(2)
Test data of Comparative Examples 1-5 (C1-C5)

| Test Data | C1 | C2 | C3 | C4 | C5 |
|---|---|---|---|---|---|
| Flame retardancy | V0 | V0 | V1 | Burning | Burning |
| (UL94) | | | | | |
| Thermally conductivity | 0.95 | 1.02 | 0.77 | 0.69 | 0.92 |
| (W/mk) | | | | | |
| Dielectrical strength | 0.45 | 0.46 | 0.48 | 0.45 | 0.41 |
| (Kv/mil) | | | | | |
| Cleavage adhesion | <0.016 | <0.016 | <0.016 | 0.031 | No |
| (MPa) | | | | | |

Result

As can be seen from table 2(1) and table 2(2), the adhesive tapes produced in the invention could offer customer a satisfied performance combination in Non-halogen flame retardant property (UL94-V1 rating), good bond strength (>0.28 MPa), high thermal conductivity (>0.60 W/m·k) and good dielectric properties (>0.30 kv/mil), as compared with the tapes of Comparative Examples 1-5. Especially, the compositions of Examples 6-9 have an excellent performance combination in Non-halogen flame retardant property (UL94-V0 rating), good bond strength (>0.40 MPa), high thermal conductivity (>0.65 W/m·k) and good dielectric properties (>0.40 kv/mil).

Although the aforementioned detailed description contains many specific details for purposes of illustration, one of ordinary skill in the art will appreciate that many variations, changes, substitutions, and alterations to the details are within the scope of the invention as claimed. Accordingly, the invention described in the detailed description is set forth without imposing any limitations on the claimed invention. The proper scope of the invention should be determined by the following claims and their appropriate legal equivalents.

1. A halogen-free pressure-sensitive adhesive composition, based on the total weight of the composition, comprising (A) 15˜60 wt % of acrylic-based polymer, (B) 10˜50 wt % of thermally conductive filler, and (C) 20˜50 wt % of halogen-free flame retardant, based on 100 wt % of the total weight of the composition, wherein the component (C) comprises: sub-component (C1) comprising at least one organophosphorous-based flame retardant; and sub-component (C2) comprising at least one flame retardant selected from the group consisting of nitrogen-containing compound-based flame retardants, graphite material-based flame retardants, melamine cyanurate-based flame retardants, metal hydroxide-based flame retardants, metal oxide-based flame retardants, metal phosphate-based flame retardants and metal borate-based flame retardants, and organophosphate-based flame retardants other than the organophosphorous-based flame retardants of (C1), and the composition has a P content no less than 4.0 wt %, based on 100 wt % of the total weight of the composition.

2. The halogen-free pressure-sensitive adhesive composition as defined in claim 1, wherein said sub-component (C2) being at least one flame retardant selected from the group consisting of metal hydroxide-based flame retardant, metal oxide-based flame retardant, metal phosphate-based flame retardant and metal borate-based flame retardant, organophosphate-based flame retardant other than the organophosphorous-based flame retardant of (C1).

3. The halogen-free pressure-sensitive adhesive composition as defined in claim 1, wherein the amount of said sub-component (C1) is 10-35 wt %, based on 100 wt % of the total weight of the composition.

4. The halogen-free pressure-sensitive adhesive composition as defined in claim 1, wherein the amount of sub-component (C2) is 5-40 wt %, based on 100 wt % of the total weight of the composition.

5. The halogen-free pressure-sensitive adhesive composition as defined in claim 1, wherein said sub-component (C2) comprises at least one phosphate-based flame retardant other than the organophosphorous-based flame retardant of (C1).

6. The halogen-free pressure-sensitive adhesive composition as defined in claim 5, wherein the amount of said sub-component (C1) is 18-35 wt %, based on 100 wt % of the total weight of the composition, and the amount of said sub-component (C2) is 5-19 wt %, based on 100 wt % of the total weight of the composition.

7. The halogen-free pressure-sensitive adhesive composition as defined in any one of foregoing claim 1, wherein said sub-component (C2) comprises at least one metal hydroxide-based flame retardant.

8. The halogen-free pressure-sensitive adhesive composition as defined in claim 7, wherein said sub-component (C2) further comprises at least one metal borate-based flame retardant and/or at least one metal phosphate-based flame retardant.

9. The halogen-free pressure-sensitive adhesive composition as defined in claim 8, wherein said metal borate is zinc borate.

10. The halogen-free pressure-sensitive adhesive composition as defined in claim 8, wherein said metal phosphate is zinc phosphate.

11. The halogen-free pressure-sensitive adhesive composition as defined in claim 5, wherein the amount of said sub-component (C1) is 10-26 wt %, based on 100 wt % of the total weight of the composition, the amount of said at least one metal hydroxide-based flame retardant is 8-24 wt %, based on 100 wt % of the total weight of the composition, and the amount of said at least one metal borate-based flame retardant or metal phosphate-based flame retardant is 1-10 wt %, based on 100 wt % of said at least one metal hydroxide-based flame retardant.

12. The halogen-free pressure-sensitive adhesive composition as defined in claim 5, wherein the amount of said sub-component (C1) is 10-24 wt %, based on 100 wt % of the composition, the amount of said at least one metal hydroxide-based flame retardant is 10-21 wt %, based on based on 100 wt % of the total weight of the composition, and the amount of said at least one metal borate-based flame retardant or metal phosphate-based flame retardant is 1-10 wt %, based on 100 wt % of said at least one metal hydroxide-based flame retardant.

13. The halogen-free pressure-sensitive adhesive composition as defined in claim 5, wherein said sub-component (C2) further comprises at least one phosphate-based flame retardant other than the organophosphorous-based flame retardant of (C1).

14. The halogen-free pressure-sensitive adhesive composition as defined in claim 13, wherein the amount of said sub-component (C1) is 12-26 wt %, based on 100 wt % of the total weight of the composition, the amount of said at least one metal hydroxide-based flame retardant is 8-24 wt %, based on 100 wt % of the total weight of the composition, the amount of said at least one metal borate-based flame retardant or metal phosphate-based flame retardant is f 1-10 wt %, based on 100 wt % of said at least one metal hydroxide-based flame retardant, and the amount of at least one phosphate-based flame retardant is from 0.001-19 wt %, based on 100 wt % of the total weight of the composition.

15. The halogen-free pressure-sensitive adhesive composition as defined in claim 13, wherein the amount of said sub-component (C1) is 15-31 wt %, based on 100 wt % of the total weight of the composition, the amount of said at least one metal hydroxide-based flame retardant is 5-31 wt %, based on 100 wt % of the total weight of the composition, the amount of said at least one metal borate-based flame retardant or metal phosphate-based flame retardant is 1-10 wt %, based on 100 wt % of said at least one metal hydroxide-based flame retardant, and the amount of at least one phosphate-based flame retardant is 0.001-14 wt %, based on 100 wt % of the total weight of the composition.

16. The halogen-free pressure-sensitive adhesive composition as defined in claim 1, wherein said organophosphorous-based flame retardant is selected from the group consisting of organophosphorous salts, triphenyl phosphates, and mixtures thereof.

17. (canceled)

17. The halogen-free pressure-sensitive adhesive composition as defined in claim 1, wherein said acrylic-based polymer is at least one polymer of one or more monomer selected from the group consisting of acrylic acid, methyl acrylate, and acrylate monomers.

18. The halogen-free pressure-sensitive adhesive composition as defined in claim 1, wherein said thermally conductive and electrically insulating filler is selected from the group consisting of ceramic, metal oxides, hydrated metal compounds, metal nitrides, and hydrous metal compounds.

19. The halogen-free pressure-sensitive adhesive composition as defined in claim 1, further comprising a tackifier or a crosslinker.

21. (canceled)

22. (canceled)

20. A halogen-free pressure-sensitive adhesive tape comprising a carrier and a halogen-free pressure-sensitive adhesive layer provided on at least one surface of said carrier, said halogen-free pressure-sensitive adhesive layer comprising the halogen-free pressure-sensitive adhesive composition described in claim 1.

24. (canceled)
